(19) United States
(12) Patent Application Publication
(10) Pub. No.: US 2015/0355660 A1
(43) Pub. Date: Dec. 10, 2015

(54) ENHANCED CORE POWER REDUCTION

(71) Applicant: QUALCOMM Incorporated, San Diego, CA (US)

(72) Inventors: Hee Jun PARK, San Diego, CA (US); Steve Sungwoo LIM, San Diego, CA (US)

(21) Appl. No.: 14/298,767

(22) Filed: Jun. 6, 2014

(51) Int. Cl. G05F 3/02; G06F 1/32

(52) U.S. Cl. CPC G05F 3/02; G06F 1/3234

(57) ABSTRACT

An IC includes a first core and a second core configured to operate in a common power domain. In a case tasks are running on the at least two cores, a control circuit is configured to adjust a voltage for the common power domain based on an electrical characteristic of the first core with a higher threshold operating voltage than the second core, and to adjust an operating frequency for the second core which can run at a higher operating frequency than the first core based on the voltage for the common power domain. In another case, a task or tasks are run on one core only. An IC includes a control circuit configured to select a core with lower minimum operating voltage for the task or tasks based on electrical characteristics of the cores to lower the voltage of the common power domain.

### CROSS-REFERENCE TO RELATED APPLICATION(S)

This application is related to of U.S. Pat. No. 7,802,216, titled “Area and power saving standard cell methodology” and issued on Sep. 21, 2010, which is expressly incorporated by reference herein in its entirety.

### BACKGROUND

1. Field

The disclosure relates to electronic apparatuses and integrated circuits (ICs) and, in particular, to electronic apparatuses and ICs containing multiple cores.

2. Background

Wireless communication technologies and devices (e.g., cellular phones, tablets, laptops, etc.) have grown in popularity and use over the past several years. Increasingly, mobile electronic devices have grown in complexity and now commonly include multiple processors (e.g., baseband processor and application processor) and other resources that allow mobile device users to execute complex and power intensive software applications (e.g., music players, web browsers, video streaming applications, etc.). To meet the increasing performance demand, the processors are designed to include multiple cores. For example, each integrated circuit (IC) substrate of the processor may include multiple cores. An example of such core includes a central processing unit (CPU) and its own cache.

With the ever increasing demand for more processing capability in the wireless devices, low power consumption has become a common design requirement. Various techniques are currently being employed to reduce power consumption in such devices. U.S. Pat. No. 7,802,216, incorporated by reference herein in its entirety, provides an example of using adaptive power supply based on a sensor or matched circuit. The sensor or matched circuit includes a ring oscillator, tapped delay line, or other circuit structure that provides a delay in signal propagation. The delay may be detected using a PLL or DLL, and the power supply is adjusted accordingly.

### SUMMARY

Aspects of a method for operating an integrated circuit are disclosed. The method includes operating a first core and a second core in a common power domain, selecting the first core or the second core for a task based on an electrical characteristic of the first core and an electrical characteristic of the second core, and entering by the selected first core or second core into a low power mode or power collapse mode in response to completion of the task.

Aspects of an integrated circuit are disclosed. The integrated circuit includes a first core and a second core configured to operate in a common power domain. A control circuit is configured to adjust a voltage for the common power domain based on an electrical characteristic of the first core, which is different from an electrical characteristic of the second core, and to adjust an operating frequency for the second core based on the voltage for the common power domain.

Aspects of an integrated circuit are provided. The integrated circuit includes a first core and a second core configured to operate in a common power domain. A control circuit configured to select the first core or the second core for a task based on an electrical characteristic of the first core and an electrical characteristic of the second core, wherein the selected first core or second core enters into a low power mode or power collapse mode in response to completion of the task.

Aspects of a method for operating an integrated circuit are disclosed. The method includes operating a first core and a second core in a common power domain and adjusting a voltage for the common power domain based on an electrical characteristic of the first core, which is different from an electrical characteristic of the second core. The method further includes adjusting an operating frequency for the second core based on the voltage for the common power domain.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

FIG. 1 illustrates a wireless communication device and communication systems in which an exemplary embodiment may be included.

FIG. 2 is a block diagram of a wireless communication device in which an exemplary embodiment may be included.

FIG. 3 is a diagram illustrating a core power reduction (CPR) system.

FIG. 4 is a diagram of an exemplary embodiment operating with voltage margin.

FIG. 5 is a diagram of an exemplary embodiment with CPR system and frequency adjustment.

FIG. 6 is a diagram of an exemplary embodiment of core operations.

FIG. 7 is a diagram of an exemplary embodiment with CPR system and core selection.

FIG. 8 is a flow chart of the operations of an exemplary embodiment.

FIG. 9 is a flow chart of the operations of an exemplary embodiment.

FIG. 10 is a conceptual data flow diagram illustrating the data flow between different modules/means/components in an exemplary apparatus.

FIG. 11 is a diagram illustrating an example of a hardware implementation for an apparatus employing a processing system.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of IC design will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a mobile device and/or base station as applicable. For example, such a device can be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a mobile device and/or base station can obtain the various methods upon coupling or providing the storage means to the device. Moreover, any other suitable technique for providing the methods and techniques described herein to a device can be utilized.

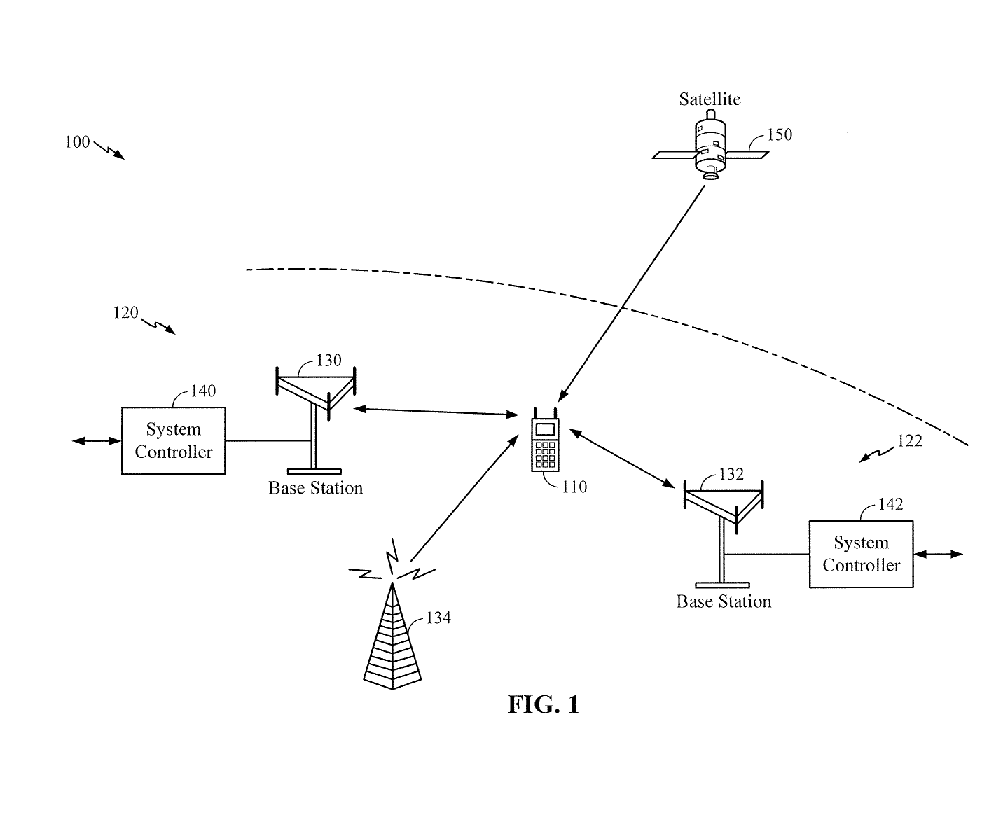

FIG. 1 illustrates a wireless communication device (e.g., wireless device 110) and communication systems (e.g., wireless systems 120 and 122) in which an exemplary embodiment may be included. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1X or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120 including one base station 130 and one system controller 140, and the wireless system 122 including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The wireless device 110 may be capable of communicating with the wireless system 120 and/or 122. The wireless device 110 may also be capable of receiving signals from broadcast stations, such as the broadcast station 134. The wireless device 110 may also be capable of receiving signals from satellites, such as the satellite 150, in one or more global navigation satellite systems (GNSS). The wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

The wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods. For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE.

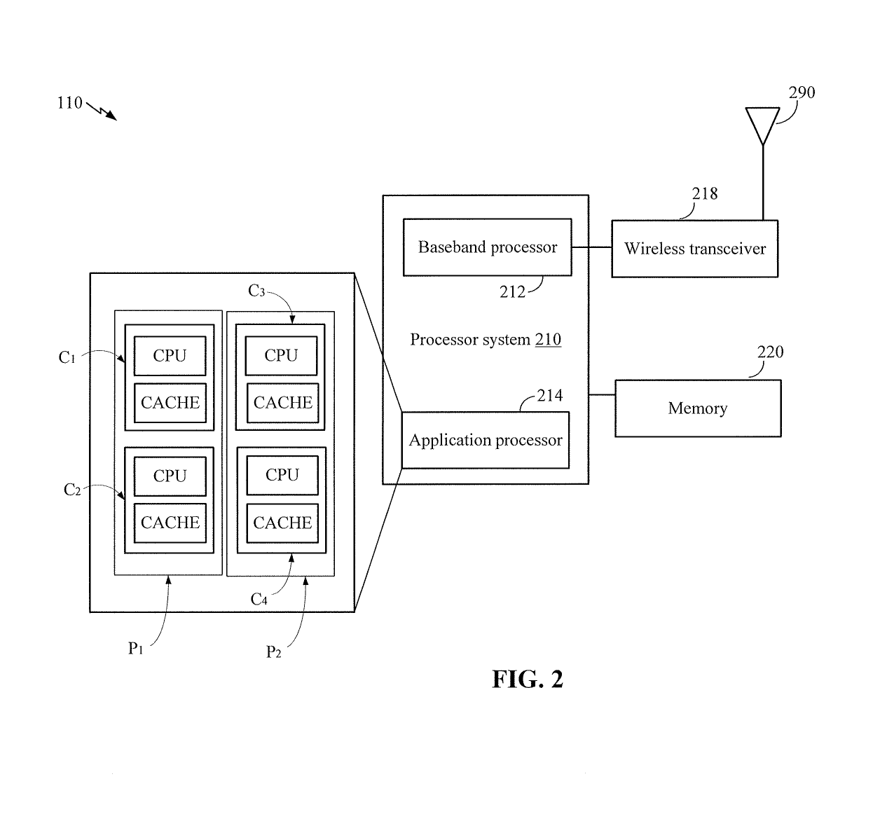

FIG. 2 illustrates a block diagram of a wireless communication device (such as the wireless device 110) in which an exemplary embodiment may be included. The wireless transceiver 218 communicates with an antenna 290 for supporting the various wireless bi-directional communications described above. For example, the wireless transceiver 218 performs the radio frequency (RF) functions of the wireless device 110. The wireless transceiver 218 may receive a digital signal for transmission from the baseband processor 212, and convert the digital signal to an analog RF signal. The analog RF signal is provided to the antenna 290 for transmission. The wireless transceiver 218 may further receive an RF signal from the antenna 290 and convert it to a digital signal. The wireless transceiver 218 may provide the digital signal to the baseband processor 212 for processing.

The wireless device 110 includes the processor system 210, which includes the baseband processor 212 and the application processor 214. The baseband processor 212 communicates with the wireless transceiver 218. In one example, the baseband processor 212 receives data (e.g., from the application processor 214) for transmission and modulates the data. The modulated data is provided to the wireless transceiver 218 as the digital signal for transmission. The baseband processor 212 may further receive a digital signal from the wireless transceiver 218. The baseband processor 212 may demodulate the received digital signal and obtain the data carried by the digital signal. The application processor 214 operates and processes the various functions of the wireless device 110 (e.g., music player, web browsers, video streaming applications, etc.). In that regard, the application processor 214 may include a graphic unit for displaying an image, a global positioning unit for locating the wireless device 110, an audio unit for telephony and music applications, and/or a connectivity unit for WiFi, near field communication, and Bluetooth functions. The processor system 210 communicates with the memory 220. Examples of the memory 220 include static random access memory (SRAM), dynamic random access memory (SRAM), flash memory, read only memory (ROM), registers, a hard disk, a removable disk, a CD-ROM, and so forth.

As an example, the application processor 214 includes four cores C₁-C₄. In one example, each of the four cores C₁-C₄ is a collection of circuits. In another example, each of the four cores C₁-C₄ includes an execution unit that manipulates (e.g., adds, subtracts, moves, or stores) data as instructed by, e.g., software. Each of the cores may be assigned or be dedicated to, e.g., the graphic function for displaying an image, a global positioning function for locating the wireless device 110, an audio function for telephony and music applications, and/or a connectivity function. As shown, each of the four cores C₁-C₄ includes a CPU (which includes an execution unit) and its own cache. The cache may be an instruction cache, a data cache, or both. The cores C₁ and C2 share a common power domain P₁, and the cores C2 and C3 share a power domain P₂. A power domain, for example, may include a group of circuits or cores which share a power supply or a set of power supplies. For example, the set of power supply or the set of power supplies may be configured to provide a same voltage to all the circuits and cores in the power domain. While the application processor 214 in a wireless device 110 is cited as an example here, a person of ordinary skill in the art would readily recognize that the scope of this disclosure is limited neither to an application processor nor to a wireless device.

Embodiments described herein provide for methods and apparatus to minimize power consumption when operating the cores based on information received from the sensors. For example, embodiments provide for providing sensors associated with the cores for outputting information corresponding to the core electrical characteristics. An electrical characteristic may be an operating speed of the core. A control circuit may receive the information corresponding to the core electrical characteristics from the sensors and configure a power supply of the power domain to provide an operating voltage to the power domain. The operating voltage may be a threshold or minimum operating voltage for the core based on a criterion. For example, the threshold operating voltage may be one that allows the core to meet a performance requirement. Moreover, the control circuit may further configure an operating frequency of the cores and/or assign a core for a task base on the information received from the sensors.

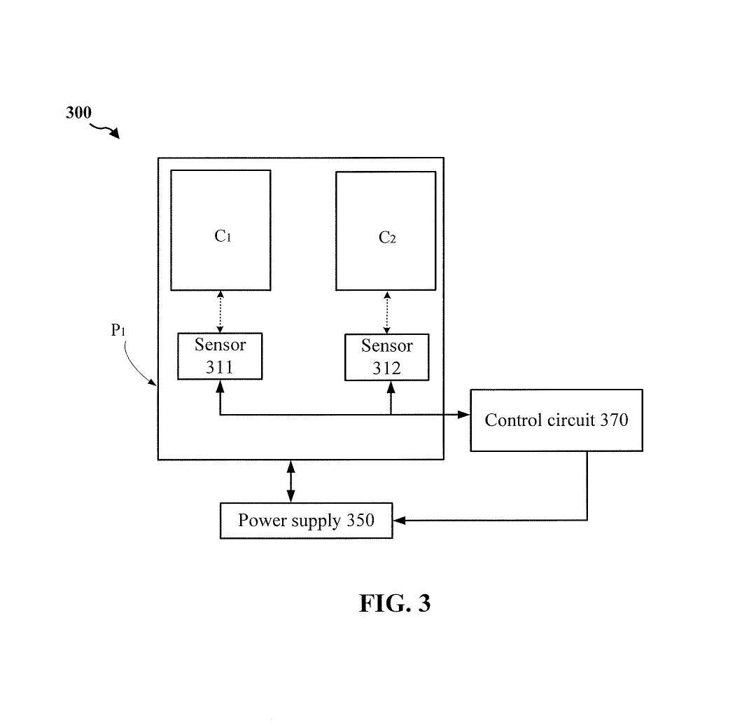

FIG. 3 is a diagram 300 illustrating a core power reduction (CPR) system. Cores C₁ and C₂ share a common power domain P₁. A sensor 311 outputs electrical characteristic information of the core C₁, and a sensor 312 outputs electrical characteristic information of the core C₂. In one example, the electrical characteristics include speed performances of the respective cores. In such cases, the sensors 311 and 312 may include a ring oscillator, tapped delay line, or other circuit structure that provides a delay in signal propagation. In one example, the sensors may be placed near the respective cores to obtain the speed information. Various factors may lead to variations in speed of the cores (and represented by the outputs of the sensors 311 and 312 near the respective cores). For example, localized process variations or temperature variations may lead the core C₂ to run faster than the core C₁. In another example, the performance of integrated circuits may degrade overtime, and the degradation may be uneven based on location. One aspect of the disclosure provides that the sensors 311 and 312 adaptively and dynamically provide electrical characteristic (e.g., speed) information of the respective cores. For example, the sensors 311 and 312 may output the electrical characteristic (e.g., speed) information of the cores at each power-up. Thus, the performance of the cores C₁ and C₂ may be controlled to account for the variations described above based on the electrical characteristic information output by the sensors 311 and 312.

A control circuit 370 may receive the electrical characteristic information output by the sensors 311 and 312. For example, the electrical characteristic information may be in the form of a timing delay detected by the control circuit 370 using a PLL or DLL. The control circuit 370 may include hardware which performs the functions described above and below, a processing element (e.g., a processor) which performs the functions described above and below, logic gates which generate the signals for performing the functions described above and below (e.g., based on instructions from a processor executing the functions), and combinations thereof.

Based on the electrical characteristic information output by the sensors 311 and 312, the control circuit 370 may determine a threshold operating voltage for the cores C₁ and C₂ (which share a common power domain P₁) and adjust a power supply 350 to provide the threshold operating voltage to the power domain P₁ (therefore, to the cores C₁ and C₂). In one example, the threshold operating voltage is determined based on the slower core (e.g., C₁). The threshold operating voltage may be determined as a voltage needed for the slower core C₁ to complete a task within a certain time period. Although the faster core C₂ may operate at a lower voltage to meet the same requirement, the core C₂ would still operate at the threshold operating voltage given that the voltage is provided by the power supply 350 to the common power domain P₁. The alternative solution of providing a separate power supply for each core may be prohibitively costly. Accordingly, the control circuit 370 is configured to adjust a voltage for the common power domain P₁ based on an electrical characteristic of the core C₁, wherein the electrical characteristic (e.g., speed) of the core C₁ is different from an electrical characteristic (e.g., speed) of the core C₂. In one example, the core C₁ requires a higher threshold operating voltage than the core C₂ for the same operating frequency. In one example, the core C₂ may be able to run at a higher operating frequency than the core C₁ at the same voltage.

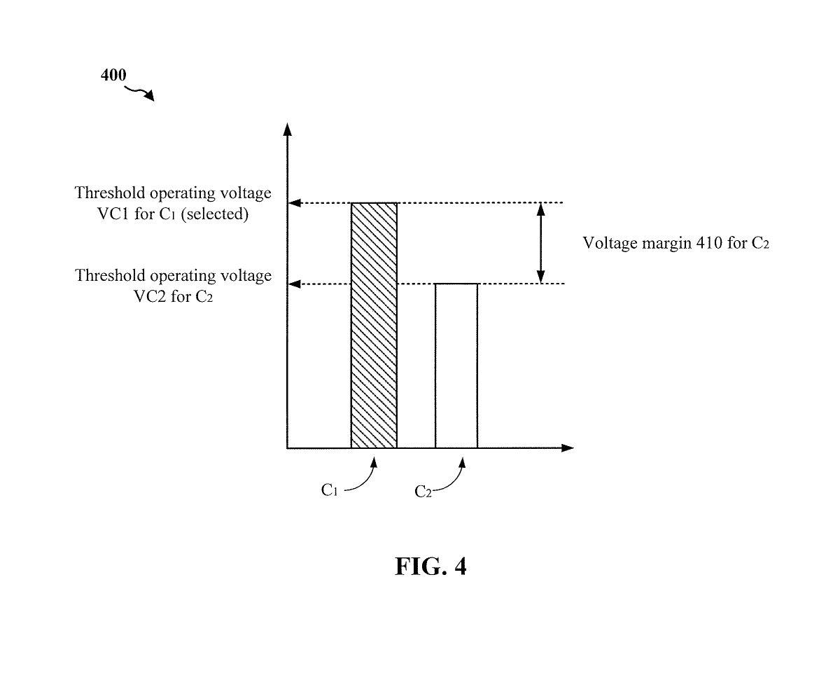

FIG. 4 is a diagram 400 of an exemplary embodiment operating with voltage margin. FIG. 4 illustrates, as determined by the control circuit 370, a threshold operating voltage VC1 for the core C₁. For example, the threshold operating voltage VC1 for the core C₁ may be a lower threshold voltage which allows the core C₁ to meet a timing requirement. For example, the threshold operating voltage VC1 may be a minimum voltage which allows the core C₁ to operate and meet certain timing requirement. A threshold operating voltage VC2 for the core C₂ may be a lower threshold voltage which allows the core C₂ to operate and meet a timing requirement. Since the core C₁ is slower than the core C₂, the threshold operating voltage VC1 for the core C₁ may be higher than the threshold operating voltage VC2 for the core C₂. The control circuit 370 may select the threshold operating voltage VC1 for the slower core C₁ as the supply voltage for the power domain P₁. Such selection may ensure the lowest operating voltage is selected while still allowing all cores to meet the timing requirement. The fast core C₂ thus operates in the higher threshold operating voltage VC1 than needed (VC2), which results in a voltage margin 410 for the core C₂.

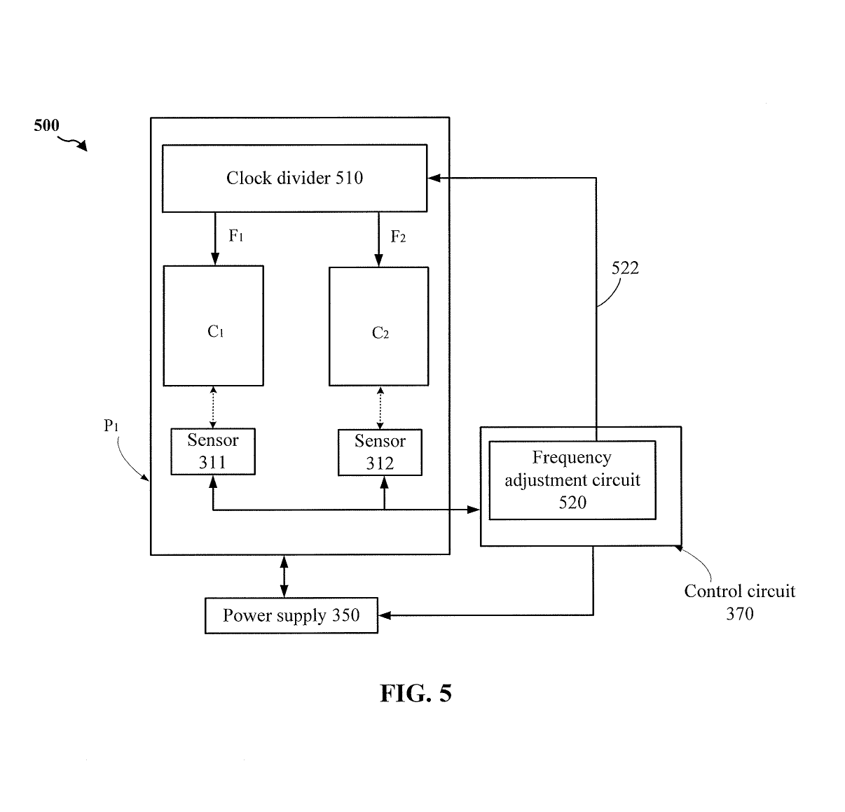

FIG. 5 is a diagram 500 of an exemplary embodiment with CPR system and frequency adjustment. One aspect of the disclosure provides that the control circuit 370 may utilize the voltage margin 410 for the core C₂ by, e.g., increasing the operating frequency of the core C₂. The control circuit 370 includes a frequency adjustment circuit 520, which determines the operating frequencies (e.g., frequency F₁ for the core C₁ and frequency F₂ for the core C₂) for the cores based on electrical characteristic information output by the sensors 311 and 312. For example, frequency adjustment circuit 520 may determine an operating frequency F₂ for the core C₂ based on VC1, which in turn is determined based on the electrical characteristic of the core C₁. The operating frequency F₂ for the core C₂ may be the upper (e.g., highest) threshold frequency for the core C₂ supported by the threshold operating voltage VC1. The operating frequency F₂ may be higher than the operating frequency F₁, thereby utilizes the voltage margin 410 of the core C₂. Accordingly, the frequency adjustment circuit 520 adjusts (522) a clock divider 510 (which is known in the art) for providing clocks at frequency F₁ to the core C₁ and at frequency F₂ to the core C₂. Accordingly, the control circuit 370 is configured to adjust an operating frequency F₂ for the second core C₂ based on the voltage VC1 for the common power domain. The control circuit 370 may further be configured to adjust an operating frequency F₁ for the second core C₁ based on the voltage VC1 for the common power domain. In one example, the operating frequency F₁ for the core C₁ may be the upper (e.g., highest) threshold frequency for the core C₁ supported by the threshold operating voltage VC1.

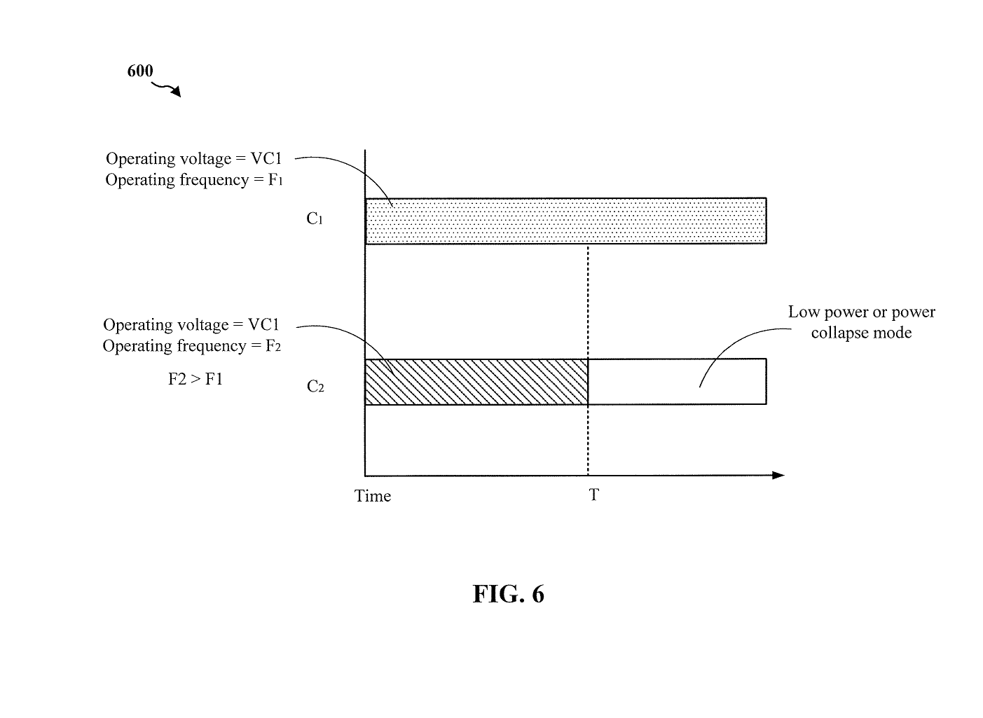

FIG. 6 is a diagram 600 of an exemplary embodiment of core operations. The core C₁ operates at the threshold operating voltage VC1 and the operating frequency F₁, and the core C₂ operates at the threshold operating voltage VC1 and the operating frequency F₂ (the operating frequency F₂ is higher than the operating frequency F₁). At time T, the core C₂ completes its assigned task, and enters into a low power or power collapse mode. The core C₂ completing its task faster than the core C₁ may be due to the core C₂ operating at the higher frequency F₂. Moreover, the core C₂ entering into the low power or power collapse mode may facilitate a reduction of power consumption.

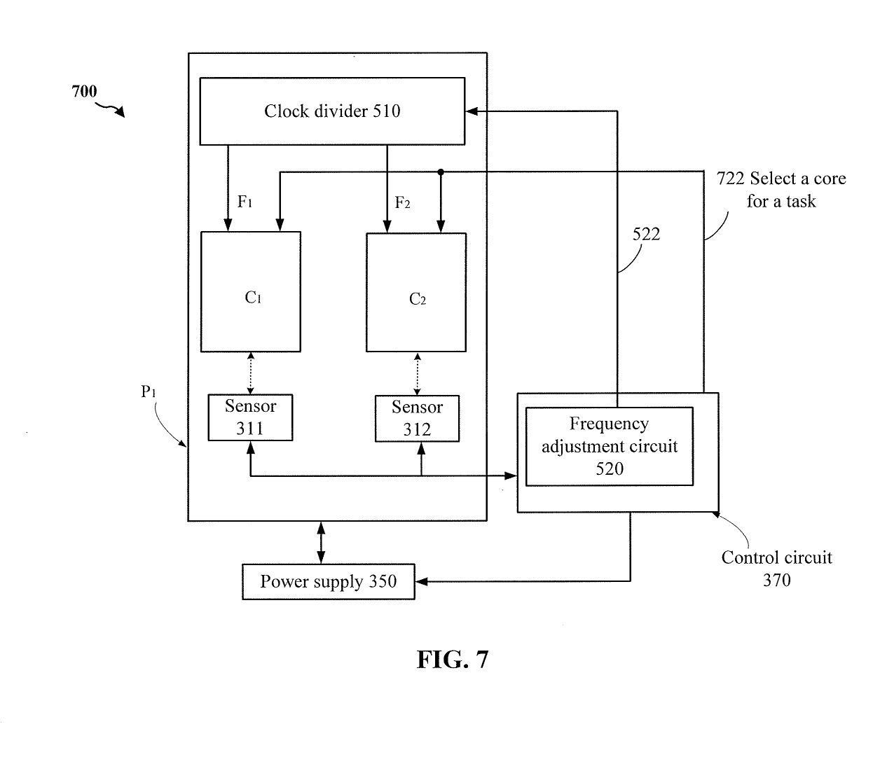

FIG. 7 is a diagram 700 of an exemplary embodiment with CPR system and core selection. One aspect of the disclosure provides that the control circuit 370 may utilize the voltage margin 410 for the core C₂ by, e.g., allocating task workload to a core among the first core C₁ and the second core C₂ having a lower threshold operating voltage (e.g., VC2 being lower than VC1) or a higher operating frequency (e.g., F₂ being higher than F₁) supported by the voltage VC1 for the common power domain. For example, based on the electrical characteristic information of the cores output by the sensor 311 and the sensor 312, the control circuit 370 selects the core C₁ or the core C₂ for a task (at 722)(both cores being available). As an example, the control circuit 370 may select the core C₂ having a lower threshold operating voltage VC2 or a higher operating frequency F₂ supported by the voltage VC1 for the common power domain P₁. The control circuit 370 may determine the threshold operating voltages and operating frequencies based on the electrical characteristic (e.g., speed performances) information output by the sensors 311 and 322. Upon completion of the task, the selected core C₂ may enter a low power or power collapse mode to facilitate a reduction in power consumption, as described above.

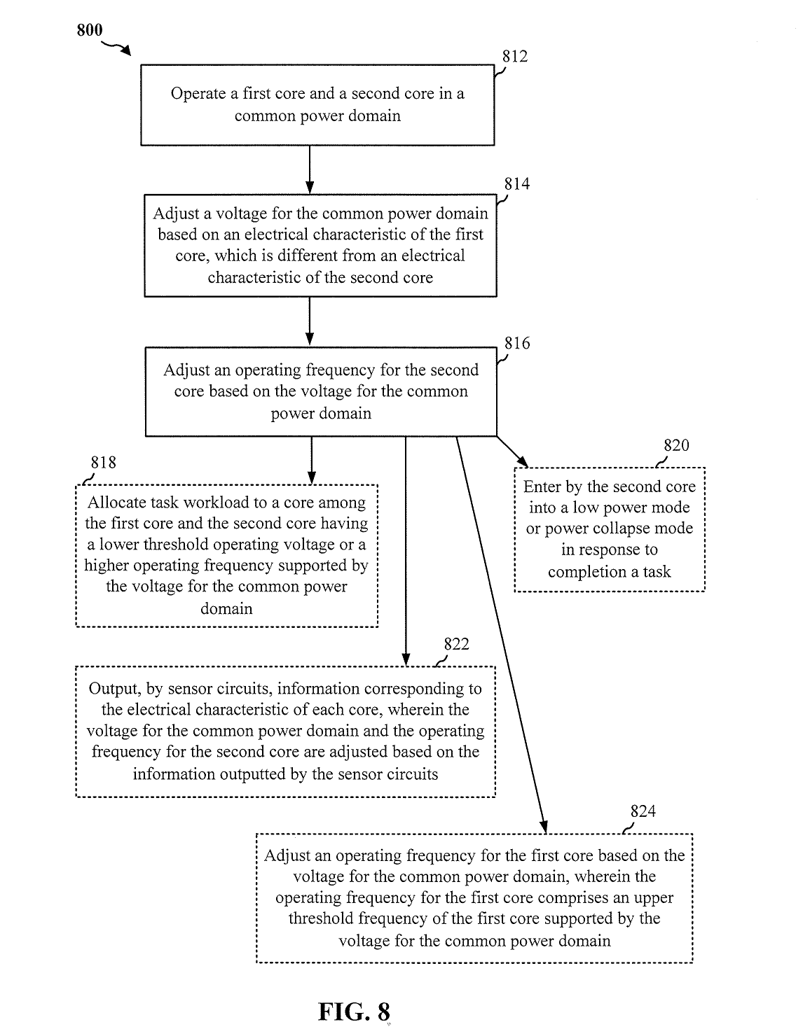

FIG. 8 is a flow chart 800 of the operations of an exemplary embodiment. The steps shown in dotted lines may be optional. Examples of the steps are found in FIGS. 3-7 and the accompanying descriptions. At 812, a first core and a second core operate in a common power domain. See, e.g., FIG. 5 providing that the core C₁ and the core C₂ operate in a common power domain P₁. At 814, a voltage for the common power domain is adjusted based on an electrical characteristic of the first core, which is different from an electrical characteristic of the second core. See, e.g., FIG. 3 and the accompanying description. For example, based on the electrical characteristic information output by the sensors 311 and 312, the control circuit 370 may determine a threshold operating voltage for the cores C₁ and C₂ (which share a common power domain P₁) and adjust a power supply 350 to provide the threshold operating voltage to the power domain P₁ (therefore, to the cores C₁ and C₂). In one example, the threshold operating voltage is determined based on the slower core (e.g., C₁). The threshold operating voltage may be determined as a voltage needed for the slower core C₁ to complete a task within a certain time period. Although the faster core C₂ may operate at a lower voltage to meet the same requirement, the core C₂ would still operate at the threshold operating voltage given that the voltage is provided by the power supply 350 to the common power domain P₁. The alternative solution of providing a separate power supply for each core may be prohibitively costly. Accordingly, the control circuit 370 is configured to adjust a voltage for the common power domain P₁ based on an electrical characteristic of the core C₁, wherein the electrical characteristic (e.g., speed) of the core C₁ is different from an electrical characteristic (e.g., speed) of the core C₂. In one example, the core C₁ requires a higher threshold operating voltage than the core C₂ for the same operating frequency. In one example, the core C₂ may be able to run at a higher operating frequency than the core C₁ at the same voltage.

At 816, an operating frequency for the second core is adjusted based on the voltage for the common power domain. See, e.g., FIG. 5 and the accompanying description. For example, referring to FIG. 5, the control circuit 370 may utilize the voltage margin 410 for the core C₂ by, e.g., increasing the operating frequency of the core C₂. The control circuit 370 includes a frequency adjustment circuit 520, which determines the operating frequencies (e.g., frequency F₁ for the core C₁ and frequency F₂ for the core C₂) for the cores based on electrical characteristic information output by the sensors 311 and 312. For example, frequency adjustment circuit 520 may determine an operating frequency F₂ for the core C₂ based on VC1, which in turn is determined based on the electrical characteristic of the core C₁. The operating frequency F₂ for the core C₂ may be the upper (e.g., highest) threshold frequency for the core C₂ supported by the threshold operating voltage VC1. The operating frequency F₂ may be higher than the operating frequency F₁, thereby utilizes the voltage margin 410 of the core C₂. Accordingly, the frequency adjustment circuit 520 adjusts (522) a clock divider 510 (which is known in the art) for providing clocks at frequency F₁ to the core C₁ and at frequency F₂ to the core C₂. Accordingly, the control circuit 370 is configured to adjust an operating frequency F₂ for the second core C₂ based on the voltage VC1 for the common power domain. The control circuit 370 may further be configured to adjust an operating frequency F₁ for the second core C₁ based on the voltage VC1 for the common power domain. In one example, the operating frequency F₁ for the core C₁ may be the upper (e.g., highest) threshold frequency for the core C₁ supported by the threshold operating voltage VC1.

At 818, task workload is allocated to a core among the first core and the second core having a lower threshold operating voltage or a higher operating frequency supported by the voltage for the common power domain. See, e.g., FIG. 7 and the accompanying description. For example, referring to FIG. 7, the control circuit 370 may utilize the voltage margin 410 for the core C₂ by, e.g., allocating task workload to a core among the first core C₁ and the second core C₂ having a lower threshold operating voltage (e.g., VC2 being lower than VC1) or a higher operating frequency (e.g., F₂ being higher than F₁) supported by the voltage VC1 for the common power domain. For example, based on the electrical characteristic information of the cores output by the sensor 311 and the sensor 312, the control circuit 370 selects the core C₁ or the core C₂ for a task (at 722) (both cores being available). As an example, the control circuit 370 may the core C₂ having a lower threshold operating voltage VC2 or a higher operating frequency F₂ supported by the voltage VC1 for the common power domain P₁. The control circuit 370 may determine the threshold operating voltages and operating frequencies based on the electrical characteristic (e.g., speed performances) information output by the sensors 311 and 322. Upon completion of the task, the selected core C₂ may enter a low power or power collapse mode to facilitate a reduction in power consumption, as described above.

At 820, the second core enters into a low power mode or power collapse mode in response to completion a task. See, e.g., FIG. 6 and the accompanying description. For example, referring to FIG. 6, the core C₂ completes its assigned task at time T, and enters into a low power or power collapse mode. The core C₂ completing its task faster than the core C₁ may be due to the core C₂ operating at the higher frequency F₂. Moreover, the core C₂ entering into the low power or power collapse mode may facilitate a reduction of power consumption.

At 822, sensor circuits output information corresponding to the electrical characteristic of each core, wherein the voltage for the common power domain and the operating frequency for the second core are adjusted based on the information output by the sensor circuits. At 824, an operating frequency for the first core is further adjusted based on the voltage for the common power domain. The operating frequency for the first core comprises an upper threshold frequency of the first core supported by the voltage for the common power domain. See, e.g., FIG. 5 and accompanying description. For example, see the description provided for step 816.

In a design with more than two cores in the common power domain, the order of cores can be determined in the order of threshold operating voltage. For example, the second core has a higher threshold operating voltage than the third core, and the third core has a higher threshold operating voltage than the fourth core. The same method applied to the first core and second cores above can be applied to the first core and N-th core. For example, a method for operating an integrated circuit may include outputting, by N or a plurality of sensor circuits, electrical characteristics indicating threshold operating voltages of N cores. The process described above is a case where N is two. The method further includes selecting cores for tasks (e.g., by the control circuit 370) based on an ascending order of the threshold operating voltages of the N cores. Thus, a core having a lower threshold operating voltage is selected before a core having a higher threshold operating voltage. For example, the second core C₂ having a lower threshold operating voltage VC2 is selected for a task before the first core C₁ having a higher threshold operating voltage VC1.

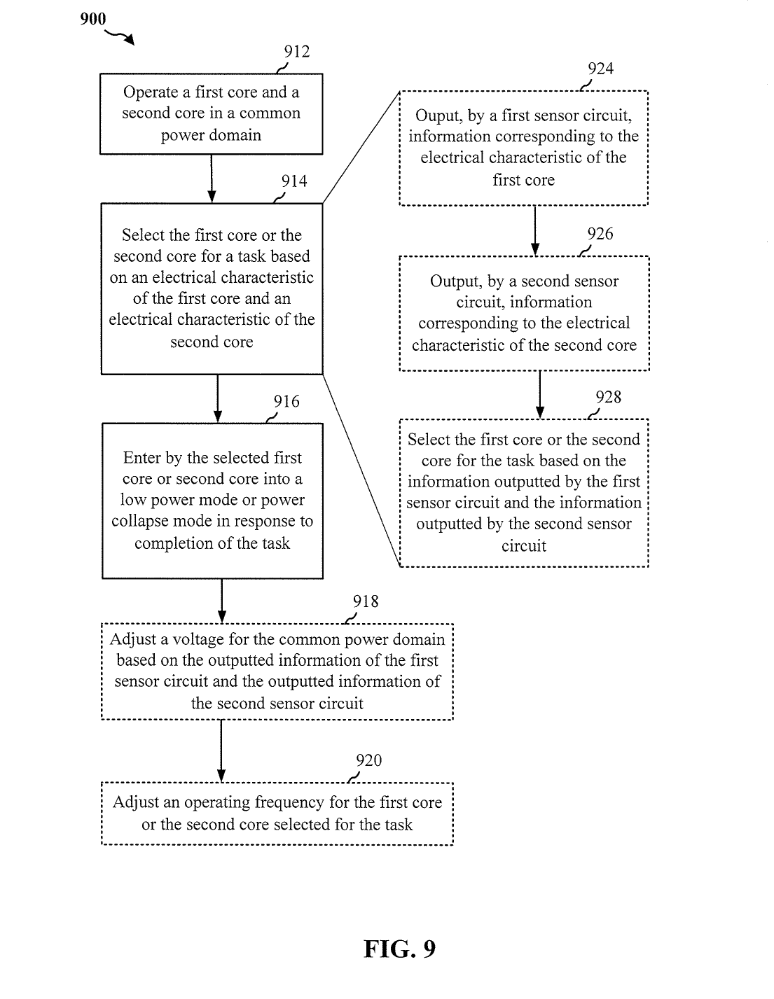

FIG. 9 is a flow chart 900 of the operations of an exemplary embodiment. The steps shown in dotted lines may be optional. Examples of the steps are found in FIGS. 3-7 and the accompanying descriptions. At 912, a first core and a second core in operate a common power domain. See, e.g., the disclosure provided for 812. At 914, the first core or the second core is selected for a task based on an electrical characteristic of the first core and an electrical characteristic of the second core. See, e.g., the disclosure provided for 818. At 916, the selected first core or second core enters into a low power mode or power collapse mode in response to completion of the task. See, e.g., the disclosure provided for 820.

At 924, a first sensor circuit outputs information corresponding to the electrical characteristic of the first core. At 926, a second sensor circuit outputs information corresponding to the electrical characteristic of the second core. At 928, the first core or the second core is selected for the task based on the information output by the first sensor circuit and the information output by the second sensor circuit. For these steps, see, e.g., the disclosure provided for 818 and 822.

At 918, a voltage for the common power domain is adjusted based on the output information of the first sensor circuit and the output information of the second sensor circuit. See, e.g., the disclosure provided for 814 and 822. At 920, an operating frequency is adjusted for the first core or the second core selected for the task. See, e.g., the disclosure provided for 816 and 818.

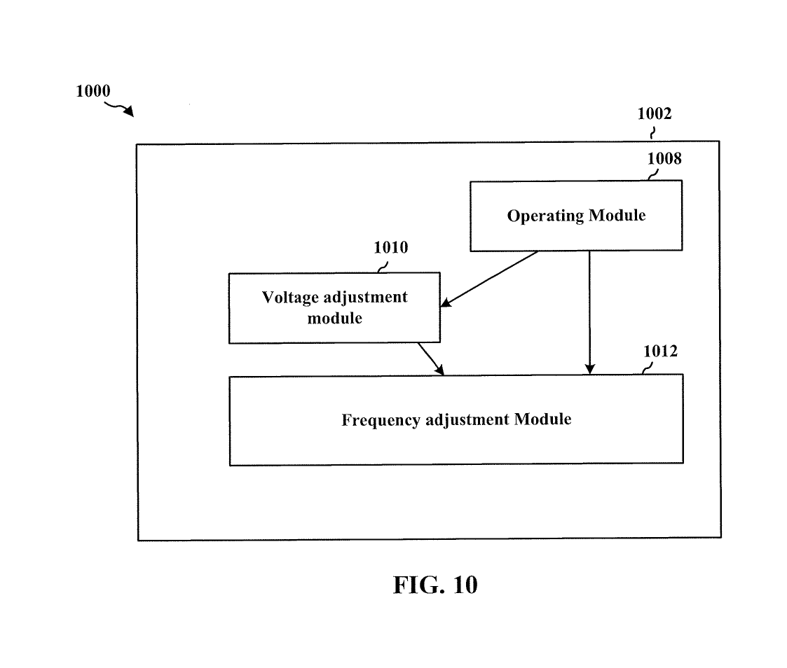

FIG. 10 is a conceptual data flow diagram 1000 illustrating the data flow between different modules/means/components in an exemplary apparatus 1002. The apparatus 1002 may be a computer or a processor coupled to a memory for initiating the modules in hardware or software. For example, for a firmware and/or software implementation, the methodologies may be implemented with the modules (e.g., procedures, functions, and the like) that perform the steps described in FIG. 8. Any machine-readable medium tangibly embodying instructions may be used in implementing this routine. The apparatus 1002 includes an operating module 1008 that operates a first core and a second core in a common power domain. A voltage adjustment module 1010 adjusts a voltage for the common power domain based on an electrical characteristic of the first core, which is different from an electrical characteristic of the second core. A frequency adjust module 1012 adjusts an operating frequency for the second core based on the voltage for the common power domain.

The apparatus may include additional modules that perform (or provide the means for) each of the steps of the algorithm in the aforementioned flow chart of FIG. 8. As such, each step in the aforementioned flow chart of FIG. 8 may be performed by a module and the apparatus may include one or more of those modules. For example, the operating module 1008 provides the means for operating a first core and a second core in a common power domain. The voltage adjustment module 1010 the means for adjusting a voltage for the common power domain based on an electrical characteristic of the first core, which is different from an electrical characteristic of the second core. The frequency adjust module 1012 provides the means for an operating frequency for the second core based on the voltage for the common power domain. Additional module may include a second operating module for providing the means for entering the second core into a low power mode or power collapse mode in response to completion a task and a an allocation module for providing the means for allocating task workload to a core among the first core and the second core having a lower threshold operating voltage or a higher operating frequency supported by the voltage for the common power domain. The modules may be one or more hardware components specifically configured to carry out the stated processes/algorithm, implemented by a processor configured to perform the stated processes/algorithm, stored within a computer-readable medium for implementation by a processor, or some combination thereof.

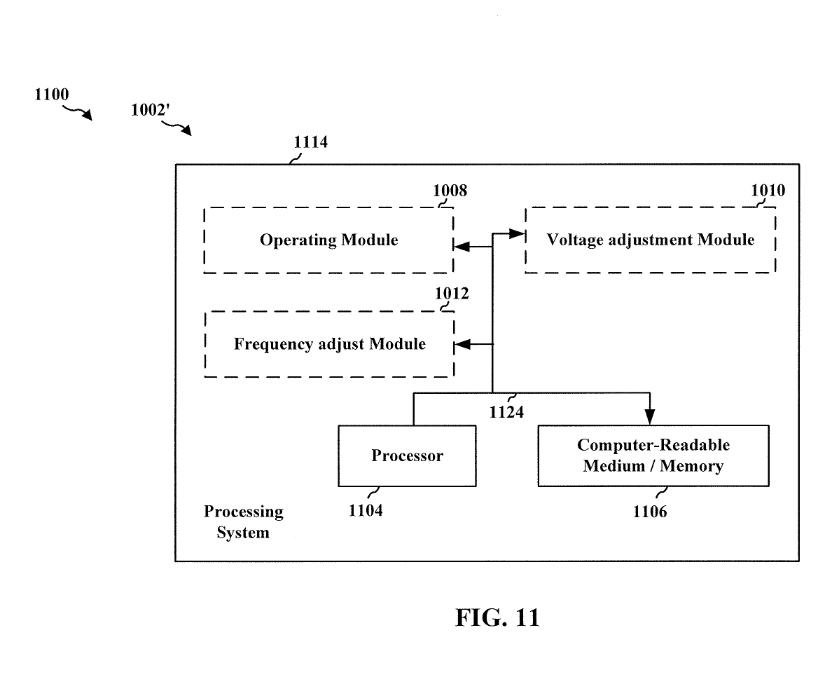

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1008, 1010, 1012 and the computer-readable medium/memory 1106. The bus 1124 may also link various other circuits such as timing sources, peripherals, voltage regulators, and power management circuits, which are well known in the art, and therefore, will not be described any further.

The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system further includes at least one of the modules 1008, 1010, and 1012. The modules may be software modules running in the processor 1104, resident/stored in the computer readable medium/memory 1106, one or more hardware modules coupled to the processor 1104, or some combination thereof.

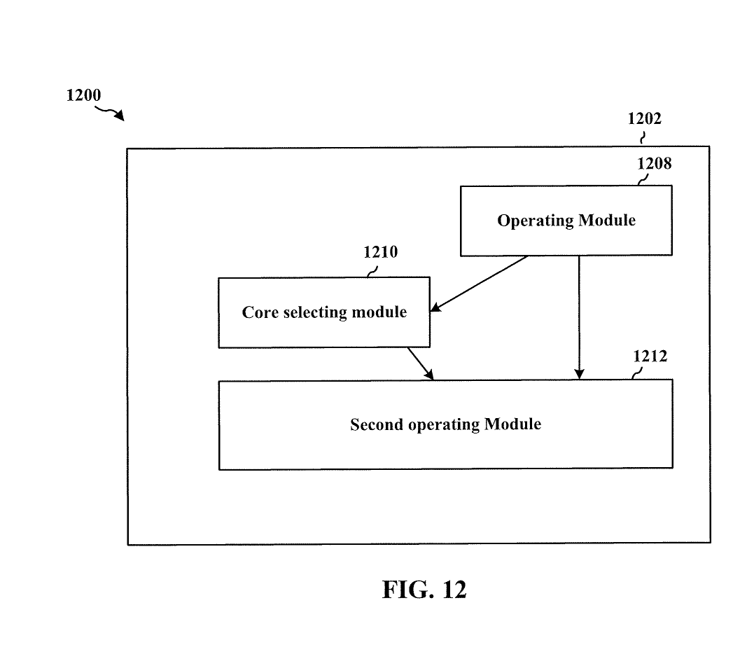

FIG. 12 is a conceptual data flow diagram 1200 illustrating the data flow between different modules/means/components in an exemplary apparatus 1202. The apparatus 1202 may be a computer or a processor coupled to a memory for initiating the modules in hardware or software. For example, for a firmware and/or software implementation, the methodologies may be implemented with the modules (e.g., procedures, functions, and the like) that perform the steps described in FIG. 9. Any machine-readable medium tangibly embodying instructions may be used in implementing this routine. The apparatus 1202 includes an operating module 1208 that operates a first core and a second core in a common power domain. A core selecting module 1210 selects the first core or the second core for a task based on an electrical characteristic of the first core and an electrical characteristic of the second core. A second operating module 1212 enters the selected first core or second core into a low power mode or power collapse mode in response to completion of the task.

The apparatus may include additional modules that perform (or provide the means for) each of the steps of the algorithm in the aforementioned flow chart of FIG. 9. As such, each step in the aforementioned flow chart of FIG. 9 may be performed by a module and the apparatus may include one or more of those modules. For example, the operating module 1208 provides the means for operating a first core and a second core in a common power domain. The core selecting module 1210 the means for selects the first core or the second core for a task based on an electrical characteristic of the first core and an electrical characteristic of the second core. The second operating module 1212 provides the means for entering the selected first core or second core into a low power mode or power collapse mode in response to completion of the task. Additional module may include a voltage adjusting module for adjusting a voltage for the common power domain based on the output information of the first sensor circuit and the output information of the second sensor circuit and a frequency adjusting module adjusting an operating frequency for the first core or the second core selected for the task. The modules may be one or more hardware components specifically configured to carry out the stated processes/algorithm, implemented by a processor configured to perform the stated processes/algorithm, stored within a computer-readable medium for implementation by a processor, or some combination thereof.

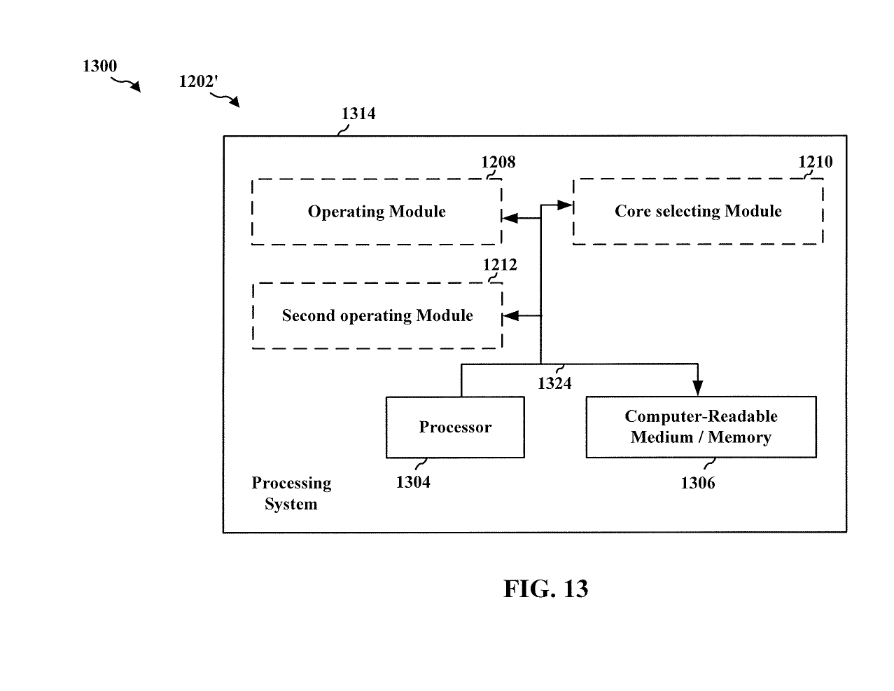

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1208, 1210, 1212 and the computer-readable medium/memory 1306. The bus 1324 may also link various other circuits such as timing sources, peripherals, voltage regulators, and power management circuits, which are well known in the art, and therefore, will not be described any further.

The processing system 1314 includes a processor 1304 coupled to a computer-readable medium/memory 1306. The processor 1304 is responsible for general processing, including the execution of software stored on the computer-readable medium/memory 1306. The software, when executed by the processor 1304, causes the processing system 1314 to perform the various functions described supra for any particular apparatus. The computer-readable medium/memory 1306 may also be used for storing data that is manipulated by the processor 1304 when executing software. The processing system further includes at least one of the modules 1208, 1210, and 1212. The modules may be software modules running in the processor 1304, resident/stored in the computer readable medium/memory 1306, one or more hardware modules coupled to the processor 1304, or some combination thereof.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An integrated circuit, comprising:
a first core and a second core configured to operate in a common power domain; and
a control circuit configured to adjust a voltage for the common power domain based on an electrical characteristic of the first core, which is different from an electrical characteristic of the second core, and to adjust an operating frequency for the second core based on the voltage for the common power domain.

2. The integrated circuit of claim 1, wherein the first core has a higher threshold operating voltage than the second core for a same operating frequency.

3. The integrated circuit of claim 1, wherein the voltage for the common power domain comprises a threshold operating voltage of the first core.

4. The integrated circuit of claim 3, wherein the operating frequency for the second core comprises an upper threshold frequency of the second core supported by the voltage for the common power domain.

5. The integrated circuit of claim 4, wherein the control circuit is further configured to adjust an operating frequency for the first core based on the voltage for the common power domain, wherein the operating frequency for the first core comprises an upper threshold frequency of the first core supported by the voltage for the common power domain.

6. The integrated circuit of claim 1, further comprising:
N cores in the common power domain, including the first core and the second core; and
a plurality of sensor circuits configured to output electrical characteristics indicating threshold operating voltages of N core,
wherein the control circuit is configured to select cores for tasks based on an ascending order of the threshold operating voltages of the N cores, and wherein a core having a lower threshold operating voltage is selected before a core having a higher threshold operating voltage.

7. The integrated circuit of claim 1, wherein the electrical characteristic comprises a speed performance associated with each core.

8. The integrated circuit of claim 1, further comprising sensor circuits configured to output information corresponding to the electrical characteristic of each core, wherein the control circuit is configured to adjust the voltage for the common power domain and adjust the operating frequency for the second core based on the information output by the sensor circuits.

9. The integrated circuit of claim 8, wherein the sensor circuits comprises a ring oscillator or a delay line circuit.

10. The integrated circuit of claim 1, wherein the control circuit is further configured to allocate task workload to a core among the first core and the second core having a lower threshold operating voltage or a higher operating frequency supported by the voltage for the common power domain.

11. An integrated circuit, comprising:
a first core and a second core configured to operate in a common power domain; and
a control circuit configured to select the first core or the second core for a task based on an electrical characteristic of the first core and an electrical characteristic of the second core, wherein the selected first core or second core enters into a low power mode or power collapse mode in response to completion of the task.

12. The integrated circuit of claim 11, further comprising
a first sensor circuit configured to output information corresponding to the electrical characteristic of the first core; and
a second sensor circuit configured to output information corresponding to the electrical characteristic of the second core,
wherein the control circuit is configured to select the first core or the second core for the task based on the information output by the first sensor circuit and the information output by the second sensor circuit.

13. The integrated circuit of claim 12, wherein the electrical characteristic of the first core or the electrical characteristic of the second core comprises a speed performance.

14. The integrated circuit of claim 12, wherein the control circuit is further configured to adjust a voltage for the common power domain based on the output information of the first sensor circuit and the output information of the second sensor circuit.

15. The integrated circuit of claim 12, wherein the control circuit is further configured to determine an operating frequency for the first core or the second core selected for the task.

16. A method for operating an integrated circuit, comprising:
operating a first core and a second core in a common power domain; and
adjusting a voltage for the common power domain based on an electrical characteristic of the first core, which is different from an electrical characteristic of the second core; and
adjusting an operating frequency for the second core based on the voltage for the common power domain.

17. The method of claim 16, wherein the first core has a higher threshold operating voltage than the second core for a same operating frequency.

18. The method of claim 16, wherein the voltage for the common power domain comprises a threshold operating voltage of the first core.

19. The method of claim 18, wherein the operating frequency for the second core comprises an upper threshold frequency of the second core supported by the voltage for the common power domain.

20. The method of claim 19, further comprising adjusting an operating frequency for the first core based on the voltage for the common power domain, wherein the operating frequency for the first core comprises an upper threshold frequency of the first core supported by the voltage for the common power domain.

21. The method of claim 16, further comprising entering by the second core into a low power mode or power collapse mode in response to completion a task.

22. The method of claim 16, wherein the electrical characteristic comprises a speed performance associated with the first core.

23. The method of claim 16, further comprising outputting, by sensor circuits, information corresponding to the electrical characteristic of each core, wherein the adjusting the voltage for the common power domain and the adjusting the operating frequency for the second core are based on the information output by the sensor circuits.

24. The method of claim 23, wherein the sensor circuits comprises a ring oscillator or a delay line circuit.

25. The method of claim 16, further comprising allocating task workload to a core among the first core and the second core having a lower threshold operating voltage or a higher operating frequency supported by the voltage for the common power domain.

26. A method for operating an integrated circuit, comprising:
operating a first core and a second core in a common power domain;
selecting the first core or the second core for a task based on an electrical characteristic of the first core and an electrical characteristic of the second core;
entering by the selected first core or second core into a low power mode or power collapse mode in response to completion of the task.

27. The method of claim 26, further comprising
outputting, by a first sensor circuit, information corresponding to the electrical characteristic of the first core; and
outputting, by a second sensor circuit, information corresponding to the electrical characteristic of the second core,
wherein the selecting the first core or the second core for the task is based on the information output by the first sensor circuit and the information output by the second sensor circuit.

28. The method of claim 27, wherein the electrical characteristic of the first core or the electrical characteristic of the second core comprises a speed performance.

29. The method of claim 27, further comprising adjusting a voltage for the common power domain based on the output information of the first sensor circuit and the output information of the second sensor circuit.

30. The method of claim 27, further comprising adjusting an operating frequency for the first core or the second core selected for the task.
